(19) United States
(12) Patent Application Publication
(10) Pub. No.: US 2020/0324666 A1
(43) Pub. Date: Oct. 15, 2020

(54) SYSTEMS AND METHODS FOR CHARGING MANAGEMENT OF CHARGING DEVICES

(71) Applicant: Noodoe Corporation, Taipei City (TW)

(72) Inventor: John C. Wang, Taipei City (TW)

(21) Appl. No.: 16/829,022

(22) Filed: Mar. 25, 2020

(30) Foreign Application Priority Data
Apr. 15, 2019 (TW) 108113109

(51) Int. Cl. B60L 53/63; B60L 53/31; B60L 53/14

(52) U.S. Cl. CPC B60L 53/63; B60L 53/14; B60L 53/31

(57) ABSTRACT

Systems and methods for charging management of charging devices for use in a server coupled to a charging device of an electric vehicle via a network are provided. First, a charging request having at least one charging code corresponding to the electric vehicle is received via network by a network connection unit. Then, it is determined whether the charging code is valid according to current condition corresponding to the charging code. When the charging code is determined as valid, first indication signal is transmitted to the charging device via network by the network connection unit to direct the charging device to output power to charge the electric vehicle which is electrically connected thereto. When the charging code is determined as invalid, second indication signal is transmitted to the charging device via network by the network connection unit to prohibit the charging device from outputting power to the electric vehicle.

### BACKGROUND OF THE INVENTION

### Field of the Invention

The disclosure relates generally to management systems and methods thereof, and, more particularly to management systems and methods that can perform related managements for charging devices of electric vehicles.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

On the other hand, based on the consideration of labor cost, charging stations usually allow users of electric vehicles to perform the charging operation of electric vehicles by themselves. Thus, in order to manage the charging station, ensuring that the users of electric vehicles use the charging station with the authorization of the relevant operators is an issue that needs to be solved urgently. Therefore, there is a need for a method and system for managing charging devices for electric vehicles that can provide simpler and more diverse charging services.

### BRIEF SUMMARY OF THE INVENTION

Systems and methods for charging management of charging devices are provided, wherein power outputted by a charging device of an electric vehicle is managed to provide simpler and diversity charging service, thus improving the practicality and utilization rate for the charging device.

In an embodiment of a method for charging management of charging devices for use in a server coupled to a charging device of an electric vehicle via a network, a charging request corresponding to the electric vehicle is first received via the network by a network connection unit, wherein the charging request includes at least one charging code. Then, it is determined whether the charging code is valid according to the charging code and predetermined usage condition corresponding to the charging code. In response to the charging code being determined as valid, first indication signal is transmitted to the charging device via the network by the network connection unit. In response to the charging code being determined as invalid, second indication signal is transmitted to the charging device via the network by the network connection unit, wherein the first indication signal directs the charging device to output power to charge the electric vehicle which is electrically connected to the charging device, and the second indication signal prohibits the charging device from outputting power to the electric vehicle.

An embodiment of a management system comprises a charging device and a server coupled to the charging device via a network. The charging device is configured to output power to charge an electric vehicle. The charging device comprises a network connection unit and a processor. The network connection unit is configured to receive a charging request corresponding to the electric vehicle via the network, wherein the charging request includes at least one charging code. The processor is coupled to the network connection unit for determining whether the charging code is valid according to the charging code and predetermined usage condition corresponding to the charging code, wherein the processor transmits a first indication signal to the charging device via the network by the network connection unit in response to the charging code being determined as valid, and the processor transmits a second indication signal to the charging device via the network by the network connection unit in response to the charging code being determined as invalid, wherein the first indication signal directs the charging device to output power to charge the electric vehicle which is electrically connected to the charging device, and the second indication signal prohibits the charging device from outputting power to the electric vehicle.

In some embodiments, the determination of whether the charging code is valid according to the charging code and the predetermined usage condition corresponding to the charging code further comprises the steps of determining whether the charging code matches one of the pre-stored authenticated codes, and determining that the charging code is invalid when the charging code does not match any of the pre-stored authenticated codes. In some embodiments, the method further includes obtaining current condition corresponding to the charging code, determining whether the current condition matches the predetermined usage condition when the charging code matches one of the pre-stored authenticated codes, determining that the charging code is invalid when the current condition does not match the predetermined usage condition, and determining that the charging code is valid when the current condition matches the predetermined usage condition.

In some embodiments, the predetermined usage condition includes a predetermined time interval, and the determination of whether the current condition matches the predetermined usage condition is performed by determining whether current time in the current condition is within the predetermined time interval and determining that the current condition matches the predetermined usage condition when the current time is within the predetermined time interval.

In some embodiments, the predetermined usage condition includes a predetermined number of code-usages, and the determination of whether the current condition matches the predetermined usage condition is performed by determining whether a current number of code-usages in the current condition is less than or equal to the predetermined number of code-usages and determining that the current condition matches the predetermined usage condition when the current number of code-usages is less than or equal to the predetermined number of code-usages.

In some embodiments, the server further provides an editing interface for manually inputting or adjusting the predetermined usage condition corresponding to the charging code.

In some embodiments, the charging device further provides an input interface for manually inputting the charging code and the charging device receives the charging code through the input interface and transmits the charging request with the charging code to the server via the network.

In sonie embodiments, the charging request is transmitted by a user device of a user corresponding to the electric vehicle.

In some embodiments, the charging code is embedded in a coded image stored on an electronic carrier or it is printed on a physical object.

In some embodiments, wherein the server further periodically receives power usage information transmitted by the charging device via the network or periodically sends a request to the charging device via the network to obtain the power usage information of the charging device during the period when the charging device is outputting power to charge the electric vehicle.

Methods for charging management of charging devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for charging management of charging devices of the invention;

FIG. 2 is a schematic diagram illustrating an embodiment of a server of the invention;

FIG. 3 is a flowchart of an embodiment of a method for charging management of charging devices of the invention;

FIG. 4 is a flowchart of another embodiment of a method for charging management of charging devices of the invention;

FIG. 5 is a flowchart of yet another embodiment of a method for charging management of charging devices of the invention; and

FIG. 6 is a flowchart of still another embodiment of a method for charging management of charging devices of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Systems and methods for charging management of charging devices are provided.

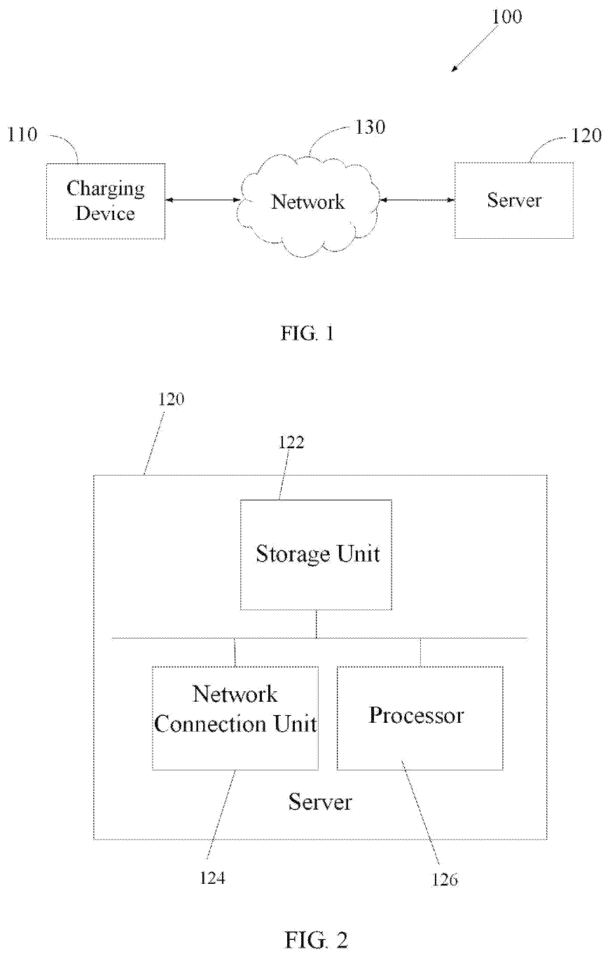

FIG. 1 is a schematic diagram illustrating an embodiment of a system for charging management of charging devices of the invention. As shown in FIG. 1, the system for charging management of charging devices 100 of the present invention comprises a charging device 110 and a server 120. In some embodiments, the charging device 110 can be coupled to the server 120 via a network 130 such as a wired network, a telecommunication network, and a wireless network, such as a Wi-Fi network or the like. The server 120 may generate an instruction and transmit it to the charging device 110 via the network 130, so as to allow the charging device 110 to output power to an electric vehicle (for example, an electric scooters or an electric car which is electronically connected to the charging device 110 or prohibit the charging device 110 from outputting power to the electric vehicle. The charging device 110 can output power for charging at least one electric vehicle. In one embodiment, the charging device 110 may be utilized for charging an electric vehicle. In another embodiment, the charging device 110 may be utilized for charging two or more electric vehicles.

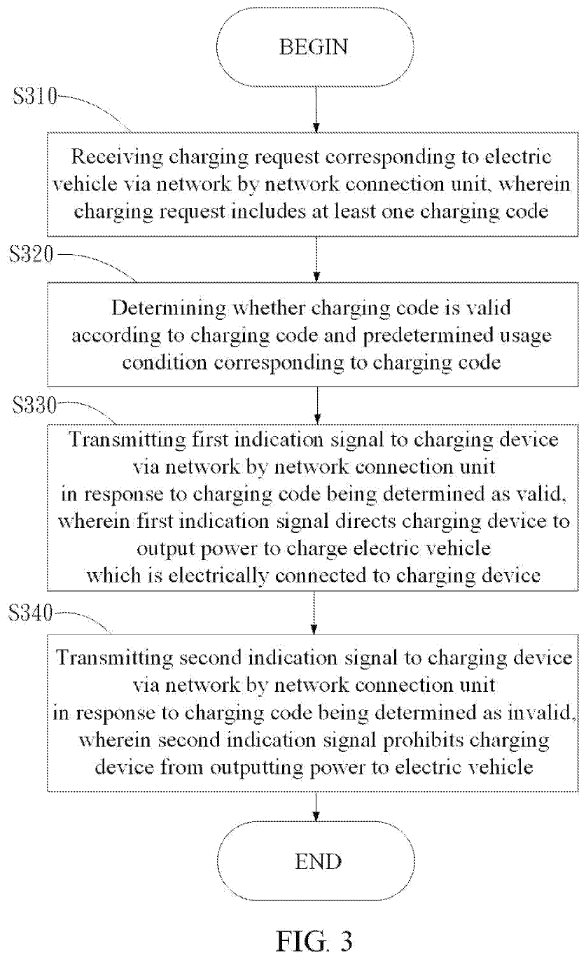

FIG. 2 is a schematic diagram illustrating an embodiment of a server of the invention. As shown in FIG. 2, the server 120 of the invention can be any processor-based electronic device, which comprises at least a storage unit 122, a network connection unit 124, and a processor 126. It is noted that, the server 120 can perform charging management operations of a charging device 110. The network connection unit 124 can receive the corresponding coupling of different charging devices via a network 130, such as a wired network, a telecommunication network, and a wireless network, such as a Wi-Fi network, and it can transmit related data to different charging devices 110 via the network 130 to control the charging device 110 whether to output electric power to charge an electric vehicle. The storage unit 122 (e.g., a memory) can store and record related data, such as registered/authenticated codes, and information about predetermined usage condition corresponding to each registered/authenticated code. It is noted that, above data is merely examples of the application, and the present invention is not limited thereto. Through the network connection unit 122, the server 120 can be coupled to the charging device 110 and communicate with each other via the network 130. The processor 126 can control related operations of software and hardware in the server 120 to perform the method for charging management of charging devices of the invention, the details of which will be described later. For example, the processor 126 can be a general-purpose controller, a micro-control unit (MCU), a digital signal processor (DSP), or the like, which provides the function of data analyzing, processing and computing. However, it is understood that the present invention is not limited thereto.

FIG. 3 is a flowchart of an embodiment of a method for charging management of charging devices of the invention. The method for charging management of charging devices of the invention can be used in a server, such as the server 120 as shown in FIG. 1 and FIG. 2, and performed by the processor 126 of the server 120. The server 120 can be coupled to a charging device 110 via a network 130 such as a wired network, a telecommunications network, and a wireless network such as a network.

First, in step S310, a charging request corresponding to an electric vehicle is received via the network by a network connection unit, wherein the charging request includes at least one charging code. In one embodiment, the charging code may be a combination of a group of numbers, such as “0012345”, “5001236789”, or the like, but it is not limited thereto. In another embodiment, the charging code may be a combination of English letters and numbers, such as “AB00123”, “000567CD01”, or the like, but it is not limited thereto. In some embodiments, the charging device may further provide an input interface for a user corresponding to the electric vehicle, such as an electric scooter or an electric car to manually input the charging code, and the charging device may receive the charging code through the input interface and transmit the charging request including the charging code to the server for authentication via the network. In other embodiments, the charging request can be transmitted from a user device of a user for the electric vehicle to the server via the network. The user device can be any electronic device with an Internet capability, such as a mobile device, such as a mobile phone, a smartphone, a personal digital assistant, a global positioning system, a notebook and so on. In some embodiments, the user device may be coupled to the server via a network, such as a wired network, a telecommunications network, and a wireless network, such as a Wi-Fi network. In some embodiments, a user of an electric vehicle may use his/her user device to download an application from the server and install it to enter a charging code through a user interface of this application. In some embodiments, the charging code may be included in a coded image stored on an electronic carrier (such as a mobile phone) or it may be printed on a physical object (such as a physical card or a paper card).

Next, in step S320, it is determined whether the charging code is valid according to the charging code in the charging request and a predetermined usage condition corresponding to the charging code. To be more specific, each charging code has a corresponding predetermined usage condition, and this predetermined usage condition can be used to determine whether the charging code is valid. Details on how to determine whether the charging code is valid will be described later. In one embodiment, the predetermined usage condition may include a predetermined time interval, and the charging code is determined to be valid when current usage time corresponding to the charging code falls within the predetermined time interval. Conversely, when the current usage time corresponding to the charging code is not within the predetermined time interval, the charging code is determined to be invalid. In another embodiment, the predetermined usage condition may include a predetermined number of code-usages, which indicate the number of times a specific charging code can be used for charging, and the charging code is determined to be valid when the corresponding number of code-usages of the charging code is less than or equal to the predetermined number of code-usages. Contrarily, when the number of code-usages corresponding to the charging code is greater than the predetermined number of code-usages, it is determined that the charging code is invalid. In some embodiments, the predetermined usage condition may include both a predetermined time interval and a predetermined number of code-usages. When the current usage time corresponding to the charging code falls within the predetermined time interval and the current number of code-usages corresponding to the charging code is less than or equal to the predetermined number of code-usages, it is determined that the charging code is valid. Conversely, when the usage time corresponding to the charging code is not within the predetermined time interval or the current number of code-usages corresponding to the charging code is greater than the predetermined number of code-usages, the charging code is determined to be invalid. In some embodiments, when the charging code is determined to be invalid, the charging code can be removed from a list of authenticated codes automatically. In some embodiments, when the charging of the charging device is completed, a message can be generated to report to the server via the network. After receiving the message, the server may further determine whether the charging code is still valid according to the predetermined usage conditions corresponding to the charging code. When the charging code is determined to be invalid, it can be automatically removed from the list of authenticated codes.

When it is determined that the charging code is valid (Yes in step S320), in step S330, a first indication signal is transmitted to the charging device through the network by the network connection unit, wherein the first indication signal instructs the charging device to output power to charge an electric vehicle that is electrically connected to the charging device. Contrarily, when it is determined that the charging code is invalid (No in step S320), in step S340, a second indication signal is transmitted to the charging device via the network by the network connection unit, wherein the second indication signal prohibits the charging device from outputting power to the electric vehicle. Specifically, when the charging device receives the first indication signal, it indicates that the charging request has been accepted, and the charging device will start to output power to the electric vehicle that is electrically connected to it, and start the charging operation. When the charging device receives the second indication signal, it indicates that the charging request has been rejected, and the charging device will not output power to the electric vehicle electrically connected thereto. In some embodiments, when the charging device receives the second indication signal, a prompt operation can be performed synchronously, and the user is notified that the charging code is invalid and the electric vehicle cannot be charged through a display unit or a user interface.

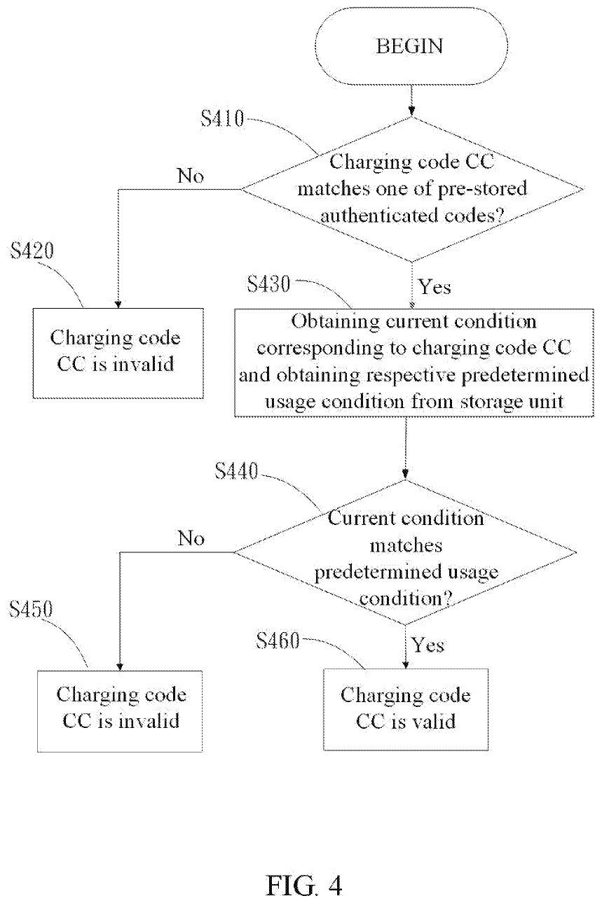

FIG. 4 is a flowchart of another embodiment of a method for charging management of charging devices for determining whether a charging code is valid of the invention. The method for determining whether the charging code is valid of the invention can be used in a server, such as the server 120 as shown in FIG. 1 and FIG. 2, wherein the server is coupled to a charging device via a network such as a wired network, a telecommunications network, and a wireless network such as a Wi-Fi network. For example, in one embodiment, the charging device can be a charging station with a charging function, which allows a user of an electric vehicle to electrically connect his electric vehicle to the charging device and charge it by entering a charging code, but the present invention is not limited thereto. In this embodiment, the server has pre-stored multiple sets of authenticated codes, and each authenticated code has a corresponding predetermined usage condition, wherein the predetermined usage condition includes a predetermined time interval. For example, the predetermined usage time interval may be, for example, 6 hours, 12 hours, 24 hours, N hours, etc., and is used to indicate a period of time limit during which a charging code can be used.

First, in step S410, it is determined whether a charging code CC matches one of the pre-stored authenticated codes. When the charging code CC does not match any of the pre-stored authenticated codes (No in step S410), in step S420, it means that the charging code CC has not been authenticated, and it is determined that the charging code CC is invalid. When the charging code CC matches one of the pre-stored authenticated codes (Yes in step S410), it means that the charging code CC has been previously authenticated, and then, in step S430, a current condition corresponding to the charging code CC is obtained and a predetermined usage condition corresponding to the charging code CC is obtained from the storage unit. To be more specific, as mentioned above, each authenticated code has a corresponding predetermined usage condition. Therefore, when the charging code CC matches a pre-stored authenticated code D, the predetermined usage condition for the charging Code CC is set as the predetermined usage condition for the authenticated code D. In this embodiment, the server can record the usage time, the number of code-usages, or the like of each charge code, and generate a corresponding record accordingly, and then obtain the current conditions corresponding to the charge code CC according to the content of the predetermined usage condition to perform further determination. For example, the processor can obtain current usage time as the current condition of the charging code CC in response to data of a predetermined time interval being included in the predetermined usage condition. Similarly, the processor can obtain a record of the number of code-usages for the charging code CC as the current condition corresponding to the charging code CC in response to data of a predetermined number of code-usages being included in the predetermined usage condition, but the present invention is not limited thereto. Next, in step S440, it is determined whether the current condition matches the predetermined usage condition. In this step, the processor may compare the predetermined usage condition with the current condition for the charging code CC according to the content of the predetermined usage condition for subsequent determination. For example, the processor can determine whether the current usage time falls within the predetermined time interval in response to data of a predetermined time interval being included in the predetermined usage condition, and if so, determine that the current condition matches the predetermined usage condition. Contrarily, when the current usage time does not fall within the predetermined time interval, it is determined that the current condition does not match the predetermined usage conditions. Similarly, the processor can obtain a record of the number of code-usages for the charging code CC as the current condition corresponding to the charging code CC in response to data of a predetermined number of code-usages being included in the predetermined usage condition and determine whether the current number of code-usages for the charge code CC is less than or equal to the predetermined number of code-usages. When the current number of code-usages for the charging code CC is less than or equal to the predetermined number of code-usages, it is determined that the current condition matches the predetermined usage condition. Contrarily, when the current number of code-usages for the charging code CC is greater than the predetermined number of code-usages, it is determined that the current condition does not match the predetermined usage condition. When the current condition does not match the predetermined usage condition (No in step S440), in step S450, it is determined that the charging code CC is invalid. Contrarily, when the current condition matches the predetermined usage condition (Yes in step S440), in step S460, it is determined that the charging code CC is valid. Similarly, as aforementioned, in response to the charging code being determined as valid, the first indication signal is transmitted to the charging device via the network by the network connection unit to direct the charging device to output power to charge the electric vehicle which is electrically connected to the charging device. In response to the charging code being determined as invalid, the second indication signal is transmitted to the charging device via the network by the network connection unit to prohibit the charging device from outputting power to the electric vehicle.

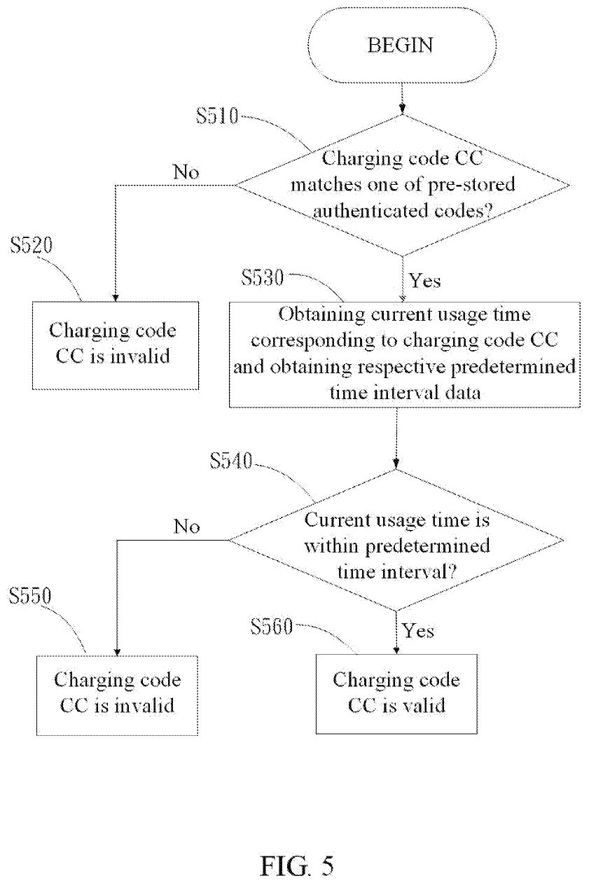

FIG. 5 is a flowchart of yet another embodiment of a method for charging management of charging devices for determining whether a charging code is valid of the invention. The method for determining whether the charging code is valid of the invention can be used in a server, such as the server 120 as shown in FIG. 1 and FIG. 2, wherein the server is coupled to a charging device via a network such as a wired network, a telecommunications network, and a wireless network such as a Wi-Fi network. For example, in one embodiment, the charging device can be a charging station with a charging function, which allows a user of an electric vehicle to electrically connect his electric vehicle to the charging device and charge it by entering a charging code CC, but the present invention is not limited thereto. In this embodiment, the server has pre-stored multiple sets of authenticated codes, and each authenticated code has a corresponding predetermined usage condition, wherein the predetermined usage condition includes a predetermined time interval. For example, the predetermined usage time interval may be, for example, 6 hours, 12 hours, 24 hours, N hours, etc., and is used to indicate a period of time limit during which the charging code CC can be used, thereby providing a time-based electric vehicle charging service.

First, in step S510, it is determined whether the charging code CC matches one of the pre-stored authenticated codes. When the charging code CC does not match any of the pre-stored authenticated codes (No in step S510), in step S520, it means that the charging code CC has not been authenticated, and it is determined that the charging code CC is invalid. When the charging code CC matches one of the pre-stored authenticated codes (Yes in step S510), it means that the charging code CC has been previously authenticated, and then, in step S530, current usage time corresponding to the charging code CC is obtained and respective predetermined time interval data included in the predetermined usage condition corresponding to the charging code CC is obtained from the storage unit. To be more specific, as mentioned above, each authenticated code has a corresponding predetermined usage condition. Therefore, when the charging code CC matches a pre-stored authenticated code D, the predetermined time interval for the charging Code CC is set to be as same as the data of the predetermined time interval for the authenticated code D. The server can record the usage time, the number of code-usages, or the like of each charge code, and generate a corresponding record accordingly, and then obtain the current conditions corresponding to the charge code CC according to the content of the predetermined usage condition to perform further determination. In this embodiment, the processor can obtain current usage time as the current condition of the charging code CC for subsequent determination in response to data of a predetermined time interval being included in the predetermined usage condition.

Next, in step S540, it is determined whether the current usage time corresponding to the charging code CC is within the predetermined time interval. When the current usage time corresponding to the charging code CC is not within the predetermined time interval (No in step S540), in step S550, it is determined that the charging code CC is invalid. Conversely, when the current usage time corresponding to the charging code CC is within the predetermined time interval (Yes in step S540), in step S560, it is determined that the charging code CC is valid. For example, in one embodiment, the charging code CC is a charging code with a predetermined valid time interval setting of “24 hours”. When the server receives the charging code CC input by a user for the first time at 9 a.m. on a certain day, it determines that the valid usage period of the charge code CC will be a time duration from now to 9:00 a.m. on next day based on the setting of predetermined valid time interval “24 hours”. Therefore, when the user uses the charging code CC once again to request the charging operation of the electric vehicle at 3 p.m. and 9 p.m., respectively, on the same day, the server can determine that the usage time of the charge code CC is within the valid usage period and thus determines that the charging code CC is valid. Therefore, it allows the charging device to output power to charge the electric vehicle which is electrically connected thereto, so as to perform the charging operation of the electric vehicle. When the user uses the charge code CC again to request the charging operation of the electric vehicle at 10 a.m. on the next morning, the server can determine that the usage time of the charge code CC is not within the valid usage period, and thus determines that the charging code CC is invalid. Therefore, the charging device is prohibited from outputting power to charge the electric vehicle for not performing the charging operation of the electric vehicle. By setting charging codes with different predetermined usage time periods, various time-based charging service plans can be provided, thus allowing users to choose appropriate charging service plan and reuse the same charging code for recharging the electric vehicle within a predetermined usage time period without needing to re-enter a new charging code for charging each time, thereby providing users with easier and more versatile charging options.

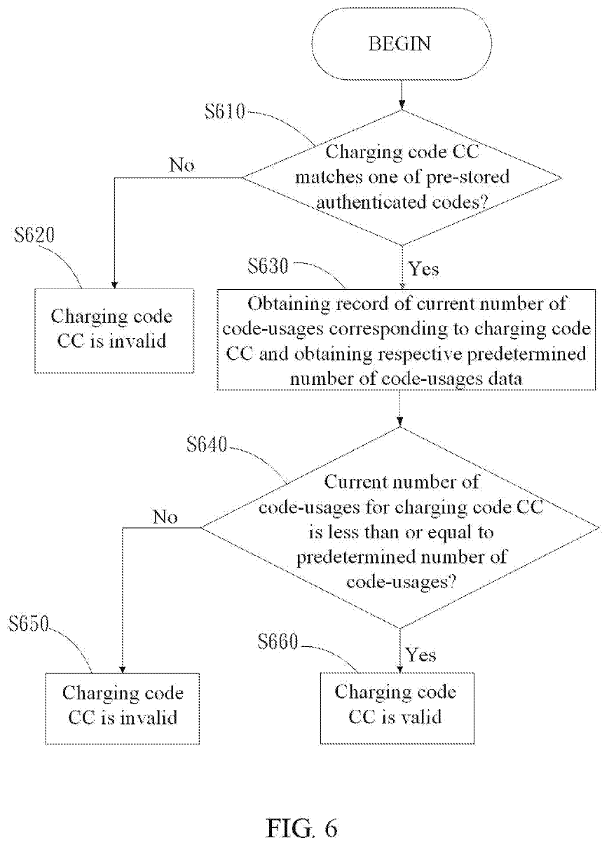

FIG. 6 is a flowchart of still another embodiment of a method for charging management of charging devices for determining whether a charging code is valid of the invention. The method for determining whether the charging code is valid of the invention can be used in a server, such as the server 120 as shown in FIG. 1 and FIG. 2, wherein the server is coupled to a charging device via a network such as a wired network, a telecommunications network, and a wireless network such as a Wi-Fi network. For example, in one embodiment, the charging device can be a charging station with a charging function, which allows a user of an electric vehicle to electrically connect his electric vehicle to the charging device and charge it by entering a charging code CC, but the present invention is not limited thereto. In this embodiment, the server has pre-stored multiple sets of authenticated codes, and each authenticated code has a corresponding predetermined usage condition, wherein the predetermined usage condition includes a predetermined number of code-usages. For example, the predetermined number of code-usages can be, for example, twice, 10 times, 50 times, N times, etc., and is used to indicate the limit of the number of times that the charging code CC can be used, thereby providing an electric vehicle charging service based on a count of the number of times that the charging code CC is being used.

First, in step S610, it is determined whether the charging code CC matches one of the pre-stored authenticated codes. When the charging code CC does not match any of the pre-stored authenticated codes (No in step S610), in step S620, it means that the charging code CC has not been authenticated, and it is determined that the charging code CC is invalid. When the charging code CC matches one of the pre-stored authenticated codes (Yes in step S610), it means that the charging code CC has been previously authenticated, and then, in step S630, a record of current number of code-usages corresponding to the charging code CC is obtained and respective predetermined number of code-usages data included in the predetermined usage condition corresponding to the charging code CC is obtained from the storage unit. To be more specific, as mentioned above, each authenticated code has a corresponding predetermined usage condition. Therefore, when the charging code CC matches a pre-stored authenticated code D, the predetermined usage condition for the charging code CC is set to be as same as the data of the predetermined usage condition for the authenticated code D. The server can record the usage time, the number of code-usages, or the like of each charge code, generate a corresponding record accordingly, and then obtain the current conditions corresponding to the charge code CC according to the content of the predetermined usage condition to perform further determination. In this embodiment, the processor can obtain current number of code-usages as the current condition of the charging code CC for subsequent determination in response to data of a predetermined number of code-usages being included in the predetermined usage condition. The server can record the usage status of the charging code CC, and obtain a record of the number of code-usages for the charging code CC by statistics. Next, in step S640, it is determined whether current number of code-usages for the charging code CC is less than or equal to the predetermined number of code-usages. When the current number of code-usages for the charging code CC is greater than the predetermined number of code-usages for the charging code CC (No in step S640), in step S650, it is determined that the charging code CC is invalid. Contrarily, when the current number of code-usages for the charging code CC is less than or equal to the predetermined number of code-usages for the charging code CC (Yes in step S640), in step S660, it is determined that the charging code CC is valid. For example, in one embodiment, the charging code CC is a charging code that can be used 10 times, and the server will count how many times the charging code CC is used. When the user uses the charging code CC to request the charging operation of the electric vehicle for less than or equal to 10 times example: 1 to 10 times), the server can determine that the current number of code-usages for the charging code CC is less than or equal to the predetermined number of code-usages for the charging code CC and thus determines that the charging code CC is valid. Therefore, it allows the charging device to output power to charge the electric vehicle to perform the charging operation of the electric vehicle. When the user uses the charging code CC to request the charging operation of the electric vehicle for more than 10 times (for example, the 11th time), the server can determine that the current number of code-usages for the charging code CC is greater than the predetermined number of code-usages for the charging code CC and thus determines that the charging code CC is valid. Therefore, the charging device is prohibited from outputting power to charge the electric vehicle for not performing the charging operation of the electric vehicle. By setting charging codes with different predetermined number of code-usages, various charging service plans based on a count of the number of times that the charging code CC is being used can be provided, thus allowing users to choose appropriate charging service plan and reuse the same charging code for recharging the electric vehicle within a predetermined number of code-usages without needing to re-enter a new charging code for charging each time, thereby providing users with easier and more versatile charging options.

In some embodiments, the predetermined usage condition may include both a predetermined time interval and a predetermined number of code-usages. When current usage time corresponding to the charging code falls within the predetermined time interval and the current number of code-usages corresponding to the charging code is less than or equal the predetermined number of code-usages, the charging code is determined to be valid. Contrarily, when the current usage time corresponding to the charging code does not fall within the predetermined time interval or the current number of code-usages corresponding to the charging code is greater than the predetermined number of code-usages, the charging code is determined to be invalid.

In some embodiments, the server may further provide an editing interface for an administrator to manually enter the predetermined usage condition data of the corresponding charging code or adjust the predetermined usage condition data of the corresponding charging code through the editing interface. For example, in one embodiment, the administrator can log into the server and enter a new charging code CC1 and set the predetermined usage condition of the charging code CC1 to be a predetermined time interval of “12 hours” through the editing interface, or the administrator can change the predetermined usage condition of predefined charging code CC2 from a predetermined usage time interval of “24 hours” to a predetermined usage time interval of “12 hours” through the editing interface, but the present invention is not limited thereto.

In some embodiments, the server may periodically receive power usage information transmitted by the charging device via the network during the period when the charging device is outputting power to charge the electric vehicle (i.e., during the charging process of the electric vehicle). To be more specific, the charging device may periodically detect and report the power usage information of the electric vehicle to the server during the charging process of the electric vehicle. In some embodiments, the server may periodically send a request to the charging device via the network to obtain the power usage information of the charging device during the period when the charging device is outputting power to charge the electric vehicle. Specifically, the server may periodically request the charging device to detect and report the charging status of the electric vehicle during the charging process of the electric vehicle to obtain the power usage information of the electric vehicle. In one embodiment, the power usage information of the electric vehicle at least includes information regarding charging status, such as a charging time, a charging progress and so on. Thereafter, the server can provide the user of the electric vehicle with information about the charging progress according to the power usage information of the charging device.

Therefore, the systems and methods for charging management of charging devices of the present invention can instruct the charging device whether or not to output power to charge the electric vehicle according to the charging code included in the charging request and respective predetermined usage condition upon receiving the charging request for the charging device via the network, thereby providing easier charging services for electric vehicles. In addition, by providing charging codes with different predetermined usage conditions, various types of charging service options can be provided, thus allowing users to reuse the same charging code for charging within the predetermined usage conditions without needing to re-enter a new charging codes for charging each time, providing simpler and variety charging options for the user and effectively increasing the practicality and utilization rate of the charging device.

Methods for charging management of charging devices, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for charging management of charging devices for use in a server, wherein the server is coupled to a charging device of an electric vehicle via a network, the method comprising:
receiving a charging request corresponding to the electric vehicle via the network by a network connection unit, wherein the charging request includes at least one charging code;
determining whether the charging code is valid according to the charging code and predetermined usage condition corresponding to the charging code;
in response to the charging code being determined as valid, transmitting a first indication signal to the charging device via the network by the network connection unit; and
in response to the charging code being determined as invalid, transmitting a second indication signal to the charging device via the network by the network connection unit,
wherein the first indication signal directs the charging device to output power to charge the electric vehicle which is electrically connected to the charging device, and the second indication signal prohibits the charging device from outputting power to the electric vehicle.

2. The method of claim 1, wherein the determination of whether the charging code is valid according to the charging code and the predetermined usage condition corresponding to the charging code further comprises the steps of:
determining whether the charging code matches one of the pre-stored authenticated codes; and
determining that the charging code is invalid when the charging code does not match any of the pre-stored authenticated codes.

3. The method of claim 2, further comprising:
when the charging code matches one of the pre-stored authenticated codes, obtaining current condition corresponding to the charging code;
determining whether the current condition matches the predetermined usage condition;
determining that the charging code is invalid when the current condition does not match the predetermined usage condition; and
determining that the charging code is valid when the current condition matches the predetermined usage condition.

4. The method of claim 3, wherein the predetermined usage condition includes a predetermined time interval, and the determination of whether the current condition matches the predetermined usage condition is performed by determining whether current usage time in the current condition is within the predetermined time interval and determining that the current condition matches the predetermined usage condition when the current usage time is within the predetermined time interval.

5. The method of claim 3, wherein the predetermined usage condition includes a predetermined number of code-usages, and the determination of whether the current condition matches the predetermined usage condition is performed by determining whether a current number of code-usages in the current condition is less than or equal to the predetermined number of code-usages and determining that the current condition matches the predetermined usage condition when the current number of code-usages is less than or equal to the predetermined number of code-usages.

6. The method of claim 1, wherein the server further provides an editing interface for manually inputting or adjusting the predetermined usage condition corresponding to the charging code.

7. The method of claim 1, wherein the charging device further provides an input interface for manually inputting the charging code and the charging device receives the charging code through the input interface and transmits the charging request with the charging code to the server via the network.

8. The method of claim 1, wherein the charging request is transmitted by a user device of a user corresponding to the electric vehicle.

9. The method of claim 1, wherein the charging code is contained in a coded image stored on an electronic carrier or printed on a physical object.

10. The method of claim 1, wherein the server further periodically receives power usage information transmitted by the charging device via the network or periodically sends a request to the charging device via the network to obtain the power usage information of the charging device during the period when the charging device is outputting power to charge the electric vehicle.

11. A management system, comprising:
a charging device configured to output power to charge an electric vehicle; and
a server coupled to the charging device via a network, comprising:
a network connection unit configured to receive a charging request corresponding to the electric vehicle via the network, wherein the charging request includes at least one charging code; and
a processor coupled to the network connection unit for determining whether the charging code is valid according to the charging code and predetermined usage condition corresponding to the charging code, wherein the processor transmits a first indication signal to the charging device via the network by the network connection unit in response to the charging code being determined as valid, and the processor transmits a second indication signal to the charging device via the network by the network connection unit in response to the charging code being determined as invalid,
wherein the first indication signal directs the charging device to output power to charge the electric vehicle which is electrically connected to the charging device, and the second indication signal prohibits the charging device from outputting power to the electric vehicle.
